(19) United States
(12) Patent Application Publication
(10) Pub. No.: US 2023/0158553 A1
(43) Pub. Date: May 25, 2023

(54) PENDULUM ROCKER BRUSH ASSEMBLY

(71) Applicant: VQ, Inc., Holland, MI (US)

(72) Inventors: Austin N. Jacobs, Allendale, MI (US); Matthew Delaney, Grand Rapids, MI (US); Ryan Essenburg, Holland, MI (US)

(21) Appl. No.: 17/532,355

(22) Filed: Nov. 22, 2021

(51) Int. Cl. B08B 1/00; B60S 3/06; A46B 13/02

(52) U.S. Cl. CPC B08B 1/002; B60S 3/063; A46B 13/02; A46B 2200/3046

(57) ABSTRACT

A pendulum rocker brush for a vehicle wash system is provided including a rocker arm, a rotatable coupler, a motor assembly, and a rocker brush head. Both the rocker brush head and motor assembly can be suspended from the coupler, freely dangling therefrom under the force of gravity, in an unbiased manner. The rocker brush head can pivot relative to the rocker arm through a swing angle between 10 and 45 degrees relative to vertical. The rotatable coupler and rocker brush head can be disposed at a pivoting angle between 10 and 45 degrees relative to a conveyor direction which a vehicle follows. When the rocker brush head encounters an opposing force above a movement threshold from the vehicle, the rocker brush head and the motor assembly can swing outward to the swing angle and at the pivoting angle so the vehicle is not damaged.

### BACKGROUND OF THE INVENTION

The present invention relates to rocker brush assemblies for use in a vehicle wash system, and more particularly, to a pendulum rocker brush assembly.

Automatic vehicle wash systems are implemented in most car washes. An automatic car wash includes a structure through which a vehicle is moved through to be cleaned. Many automatic car washes include a conveyor belt system that engages one or more wheels of the vehicle to guide, push and/or pull the vehicle through the structure. Most automatic car washes also include multiple different brushes and drums having cloth or fiber elements that move or rotate relative to a vehicle while engaging it to perform different actions on different parts of the vehicle.

One type of brush used in a car wash is a rocker brush. A rocker brush is used to clean the rocker panels and generally lower parts of a vehicle. Rocker brushes have a rocker brush head that includes flexible bristles that hang substantially vertically from a vertically disposed shaft until the rocker brush head and shaft are rotated. The rocker brush and its shaft typically are rotatably mounted on a stand anchored to the ground near a conveyor of a car wash. When the rocker brush head is actuated, it spins and the flexible bristles transition from a substantially vertical position to a substantially horizontal position due to centrifugal forces. Typical rocker brushes can damage the vehicle if the brush exerts too much force on the vehicle than is intended during normal operation. For example, if the vehicle is positioned too close to the brush, more of the brush can come in contact with the vehicle, or the brush can push too hard against the vehicle. As a result, the rocker brush can exert more force on the vehicle and damage the vehicle by denting or scratching its body panels. Alternatively, the rocker brush can scratch the surfaces of the vehicle with excess force exerted by the brush on those surfaces, particularly if there is dirt or debris matted or embedded in the brush.

Most conventional rocker brushes use gas shocks or springs, mounted between the stand and the vertical shaft, to allow the vertical shaft and rocker brush to move, while the shaft is retained in the vertical position, away from the vehicle to avoid damaging the vehicle. This requires maintenance, as the shocks and springs usually need to be carefully and repeatedly adjusted to provide appropriate forces against washed vehicles to avoid damage to the same. The shocks and springs also can wear out, and thus will need to be replaced. Further, any bearings in the rocker brush assembly associated with the movement need to be frequently monitored and greased during the lifetime of the rocker brush assembly to ensure that proper function is maintained. Some rocker brush assemblies also use rubber bumpers to keep the rocker brush a certain distance from the vehicle, to avoid damaging it. These rubber bumpers require maintenance and need to be replaced, adding further expense to the operation of the rocker assemblies.

Accordingly, there remains room for improvement in the field of rocker brush assemblies to reduce maintenance and yet still provide a solid rocker brush that can clean vehicles without damaging them.

### SUMMARY OF THE INVENTION

A rocker brush assembly is provided where the rocker brush includes a pendulum style mount which enables the rocker brush to freely swing, without the aid of external components, relative to a vehicle pathway and/or a surface of a vehicle engaged by the rocker brush, thereby providing good treatment of the vehicle surface and reducing the likelihood of damage thereto.

In one embodiment, the pendulum rocker brush assembly can include a rocker arm with a first length. The rocker arm can be fixedly attached to a structure of a car wash at a first end through a first coupler. A coupling projection can extend from and be joined with the rocker arm adjacent a second end of the rocker arm.

In another embodiment, a pivot bushing can define an aperture and a coupling surface. The aperture of the pivot bushing can be joined with the coupling projection.

In still another embodiment, a motor assembly can include a motor and a motor shroud. The motor can include a motor body and a motor shaft. The motor shroud can surround the motor body with the motor shaft extending outside the motor shroud. A top surface of the motor shroud can be joined with the coupling surface of the pivot bushing.

In yet another embodiment, a rocker brush head can include a central support member and multiple flexible bristles. The central support member can define a support aperture and the rocker brush can be joined with the motor shaft through the support aperture. The bristles can be attached at one end to an outer surface of the central support member. The bristles can be spaced evenly across the outer surface of the central support member.

In even another embodiment, the motor can rotatably actuate the rocker brush head when the motor is turned on. The flexible bristles can move from a first position to a second position when the rocker brush head is rotatably actuated. The rocker brush head and the motor assembly can be configured to pivot about the pivot bushing away from a vehicle pathway when the rocker brush head encounters an opposing force above a movement threshold.

In a further embodiment, a coupling projection can extend perpendicularly from the rocker arm adjacent a second end of the rocker arm. A rotatable coupler can define an aperture and a coupling surface. The coupling projection can be movably joined with the aperture of the rotatable coupler. A top surface of a motor shroud can be joined with the coupling surface of the rotatable coupler. A rocker brush head can be joined with a motor shaft. A motor can actuate the rocker brush head when the motor is turned on.

In still a further embodiment, both the rocker brush head and motor assembly can be suspended from the rotatable coupler, freely dangling therefrom under the force of gravity, in an unbiased manner.

In yet a further embodiment, the rocker brush head can pivot relative to the rocker arm through a swing angle between 10 and 45 degrees relative to vertical.

In even a further embodiment, the rotatable coupler and rocker brush head can be disposed at a pivoting angle between 10 degrees and 45 degrees, inclusive, or between 10 degrees and 20 degrees, inclusive, relative to a conveyor direction which a vehicle follows. Optionally, when the rocker brush head encounters an opposing force above a movement threshold from the vehicle, the rocker brush head and the motor assembly can swing outward to the swing angle and at the pivoting angle so the vehicle is not damaged.

The current embodiments of the pendulum rocker brush assembly provides efficiencies and ease of use not attainable with previous rocker panel brushes. For example, the rocker brush is freely suspended and swings like a pendulum to closely but safely follow contours of a vehicle moving along a vehicle pathway during a wash operation. The rocker brush assembly can be primarily maintenance free, as opposed to prior rocker brushes. For example, there can be no bearings to lubricate and no gas shocks or springs to replace or service in the swinging mechanism of the assembly. Further, with the simplified action of the pendulum rocker brush assembly, no complicated adjustments need be made for the assembly to work properly, and there is not a special angle at which to set the central support, because that shaft can move from a vertical orientation and swing to some other orientation offset from vertical, dynamically changing to accommodate the contours of the passing vehicle that engages the bristles on the rocker brush assembly. Further, with its ability to freely move and avoid damage to the vehicle surfaces, the assembly need not have any additional rubber bumpers to protect the vehicle.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention can be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration can be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front view of a pendulum rocker brush assembly as installed in a car wash and in motion according to one embodiment;

FIG. 2 is a front view of the pendulum rocker brush assembly as installed in a car wash but not in motion;

FIG. 3 is a perspective exploded view of a pendulum rocker brush assembly;

FIG. 4 is a top plan view of a pendulum rocker brush assembly as installed in a car wash;

FIG. 5 is an elevation view of a pendulum rocker brush assembly;

FIG. 6 is a perspective view of a pendulum rocker brush assembly; and

FIG. 7 is a top view of a pendulum rocker brush assembly.

### DETAILED DESCRIPTION OF THE CURRENT EMBODIMENTS

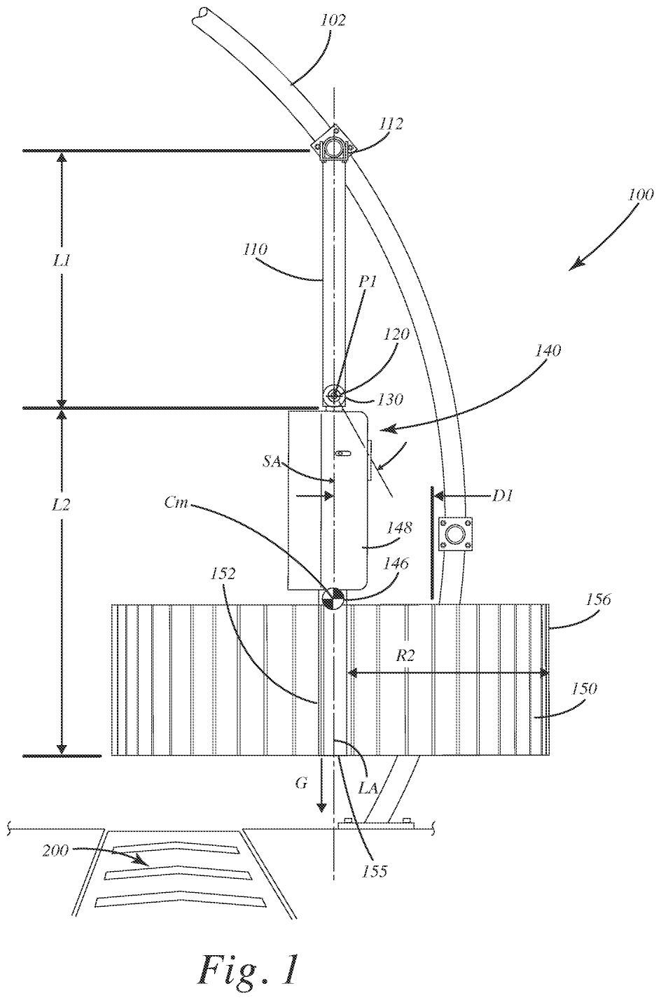

A pendulum rocker brush assembly according to one embodiment is shown in FIGS. 1-7 and generally designated 100. As shown in FIG. 1, the pendulum rocker brush assembly 100 can include a rocker arm 110. The rocker arm 110 can be fixedly attached to a car wash structure or support structure 102 via a first coupler 112, which optionally can include one or more u-bolts joined with a plate, and which can form part of the support structure. After securement to the support structure 102, which can be in the form of an arch or frame extending over an underlying vehicle pathway 200 The pendulum rocker brush assembly 100 can be moved with respect to the car wash structure 102 until it is in the appropriate location and then the rocker arm 110 can be fixedly and immovably (but adjustably) attached to the car wash structure 102. The rocker arm 110 can have a first length L1, which can be optionally between 5 and 60 inches, inclusive, between 5 and 40 inches, inclusive, between 20 and 40 inches, inclusive, between 30 and 40 inches, inclusive, between 34 and 36 inches, inclusive, or about 36 inches. A longitudinal axis LA can extend through the pendulum rocker brush assembly 100, and in particular, the rocker arm 110. This longitudinal axis can be substantially vertical in some application, or angled relative to vertical in other applications.

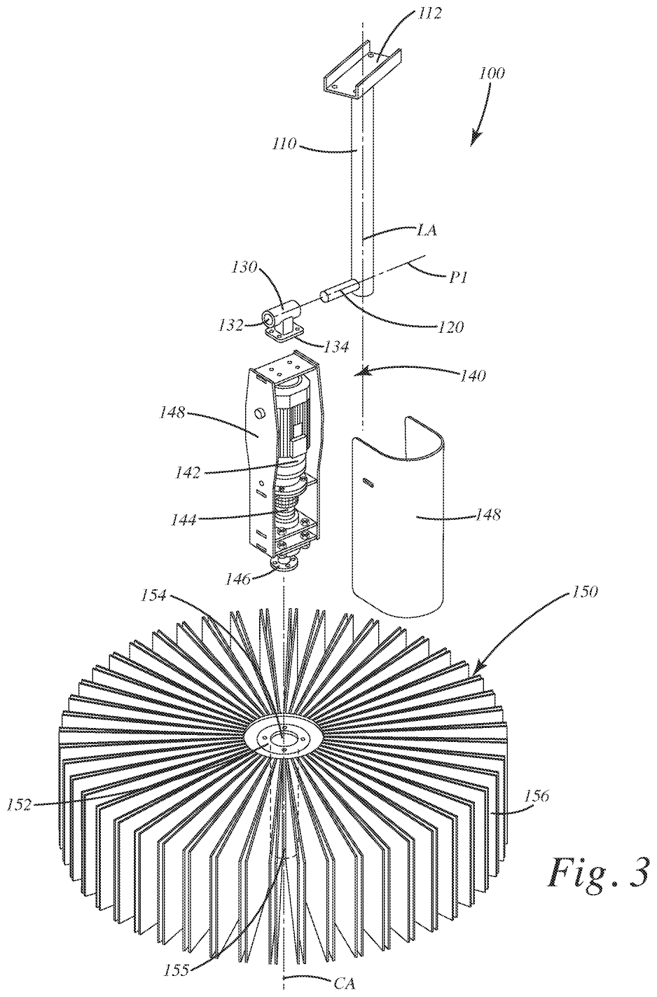

A coupling projection 120 can extend from and be joined with the rocker arm 110 adjacent a second end of the rocker arm 110. An exemplary coupling projection 120 can be seen in more detail in FIG. 3. Optionally, the coupling projection 120 can extend perpendicularly from the rocker arm 110, but alternatively, the coupling projection 120 can extend from the rocker arm 110 at any suitable angle. In some cases, the coupling projection 120 and the rocker arm 110 can form one contiguous piece.

In FIG. 3, the pendulum rocker brush assembly 100 is shown in an exploded perspective view. A rotatable coupler 130 can define an aperture 132 and a coupling surface 134. The rotatable coupler 130 can include or be in the form of a pivot bushing, a sleeve, a tube, an array of rings or hooks or some other configuration, all referred to as a pivot bushing herein. As shown, the aperture 132 can be a generally circular or cylindrical configuration, however, other configurations can be selected depending on the application. The aperture 132 can be sized and shaped to rotatably receive the coupling projection 120 therein.

This projection 120 can include or be in the form of a rod, a bar or other elongated element, which further can be of a cylindrical or other configuration depending on the application. The projection can project orthogonally from the rocker arm 110, and generally perpendicular to the longitudinal axis LA of the arm 110. The projection can be welded, fastened or integral with the rocker arm 110. The projection can be slightly longer than the coupler 130. Optionally, the projection can include a threaded bore (not shown) that received a threaded fastener therein, such that the head of the fastener captures the coupler on the projection so that the coupler does not rotate off the projection in use. Other ways to secure the coupler rotatably to the projection are contemplated as well.

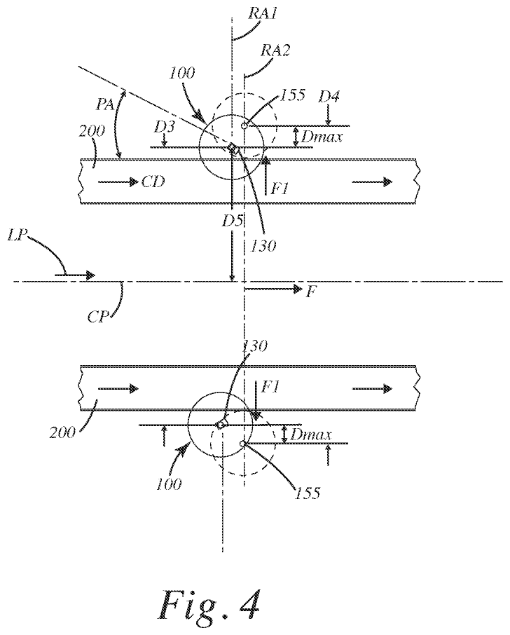

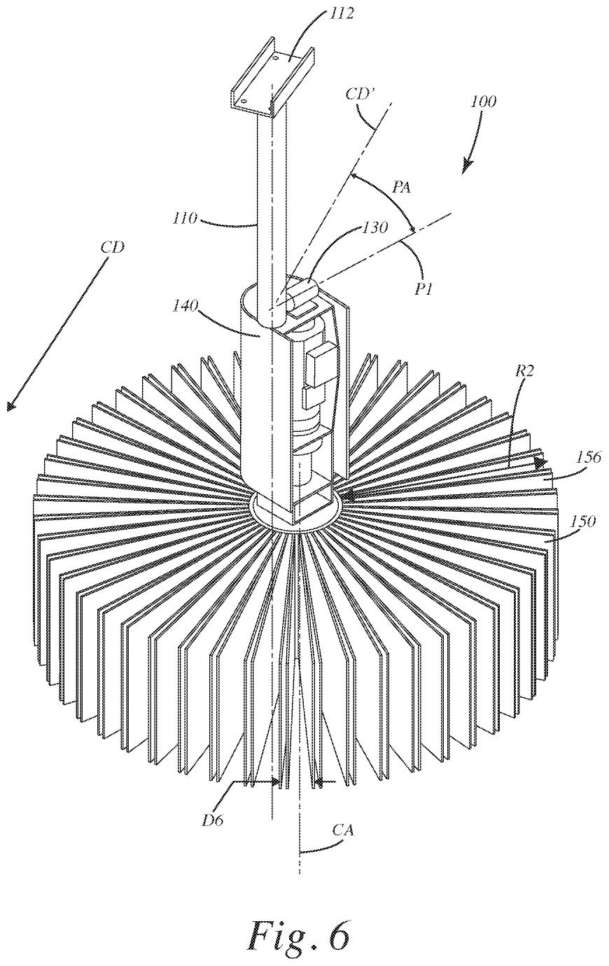

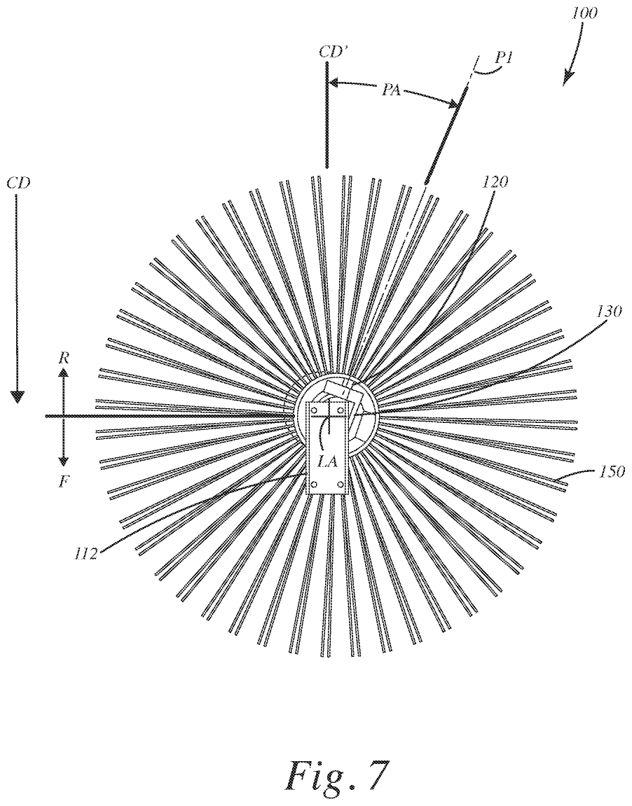

The projection fits inside the aperture and is rotatable thereto to allow everything below the coupler 130 to freely rotate, swing or pivot in an arcuate manner about a pivot axis P1 defined by the coupler and/or projection. This pivot axis P1 can intersect and/or lay along the longitudinal axis LA. Optionally, the pivot axis P1 can be offset from the conveyor direction CD as shown in FIGS. 6 and 7. For example, there, the conveyor direction CD can be parallel to a conveyor direction reference line CD′ that intersects the longitudinal axis LA. The pivot axis P1 can be offset by a pivoting angle PA from the conveyor direction reference line CD′, and thus the conveyor direction CD as well as the conveyor belt axis LP, as shown in FIG. 4. The pivot axis also can extend rearward in direction R from the longitudinal axis, away from a forward direction F as shown in FIG. 7. Further optionally, the pivoting angle PA can be optionally between 0 and 30 degrees, inclusive, between 20 and 40 degrees, inclusive, between 10 and 45 degrees, inclusive, between 15 and 45 degrees, inclusive, between 20 and 25 degrees inclusive, or about 22.5 degrees. With this angle, the rotating brush 150 and central support member 152 can swing and pivot outward from the passing vehicle easily and effectively, and tends not to bump, bounce or stutter back against the side of the vehicle surfaces uncontrollably through a wide range of RPMs. This angle also can provide adequate clearance of the brush head 150 to swing or tilt substantially away from the vehicle, while still providing adequate contact between the vehicle and bristles to enable thorough cleaning thereof.

Returning to FIG. 3, a motor assembly 140 can be joined with the rotatable coupler 130 through the coupling surface 134, which as shown can be in the form of a plate that can be bolted with fasteners to the motor assembly so that the motor assembly is suspended under the plate, hanging downward below the rocker arm and the coupler 130. The motor assembly 140, rocker head 150 and all the components thereof can be freely suspended from the coupler, without any part thereof supporting the structures from the ground surface. In this case, everything can hang freely under the force of gravity below the coupler, and can swing about the pivot axis P1 when engages by a force F1 as described below.

Optionally, although not shown, the projection and the coupler with the aperture can be reversed, so the aperture is associated with the rocker arm and the projection is associated with the motor assembly 140. The motor assembly 140 can include a motor 142 and a motor shroud 148. The motor 142 can include a motor body 144 and a motor shaft 146. The motor shroud 148 can surround the motor body 144 with the motor shaft 146 extending outside of the motor shroud 148. As shown in FIG. 3, the motor shroud 148 can include two pieces that can be fastened together to surround the motor 142. Alternatively, the motor shroud 148 can be manufactured as one piece or in more than two pieces. An upper surface of the motor shroud 148, or an upper portion of the motor assembly 140 in general, can be joined with the coupling surface 134 of the rotatable coupler 130. Optionally, although not shown, one or more weights can be fastened, joined or otherwise secured to the motor assembly or the rocker brush head distal from the pathway to flare the brush head and bristles into the vehicle on the pathway more while having the pressure adjustable thru movement of the weights. Generally, weights can be added in any position relative to the head, the motor or other parts of the assembly to increase, reduce, or adjust the pressure applied to the vehicle. These weights can be moved up and down the assembly, or around the associated axes, to tune the pressure or movement of the brush head relative to the vehicle.

Returning to FIG. 1, a rocker brush head 150 can be joined with the motor shaft 146. The rocker brush head 150 can include a central support member 152 and a plurality of flexible bristles 156. The central support member 152 can define a support aperture 154, as shown in FIG. 3. In some cases, the member 152 can be in the form of a tube or cylinder that is suspended below the motor shaft. Optionally, the rocker brush head 150 can be joined with the motor shaft 146 through the support aperture 154 of the central support member 152. The motor shaft optionally can be aligned with the central support axis CA of the central support member 152 and can extend in a vertical orientation along that central support axis CA. Further optionally, that axis CA can be laterally offset a distance D6 from the longitudinal axis LA. This distance D6 can be optionally less than 10 inches, less than 8 inches, less than 6 inches, less than 4 inches, or between 1 inch and 8 inches, inclusive.

The central support member can serve as a mounting structure for the flexible bristles 156. The bristles 156 can be constructed from a variety of materials, and can be semi-rigid, flexible, compliant, limp and/or bendable, depending on the application. The bristles 156 can be made of any suitable material. For example, the bristles 156 can be constructed from cloth, fabric, foam, polymers, silicone, microfiber and/or combinations of the foregoing. The bristles 156 can be manufactured in any manner to make them suitable for cleaning vehicles. In some cases, the each of the bristles 156 can be constructed from an elongated and/or rectangular sheet or panel of cloth or fabric that is or is not folded over on itself. In other cases, each of the bristles 156 can be twisted around itself or twisted with another bristle. Also, it is to be appreciated that although referred to as bristles, these elements can be in the form of sheets, panels, pieces of different shapes, elongated elements and the like, and may or may not be rigid.

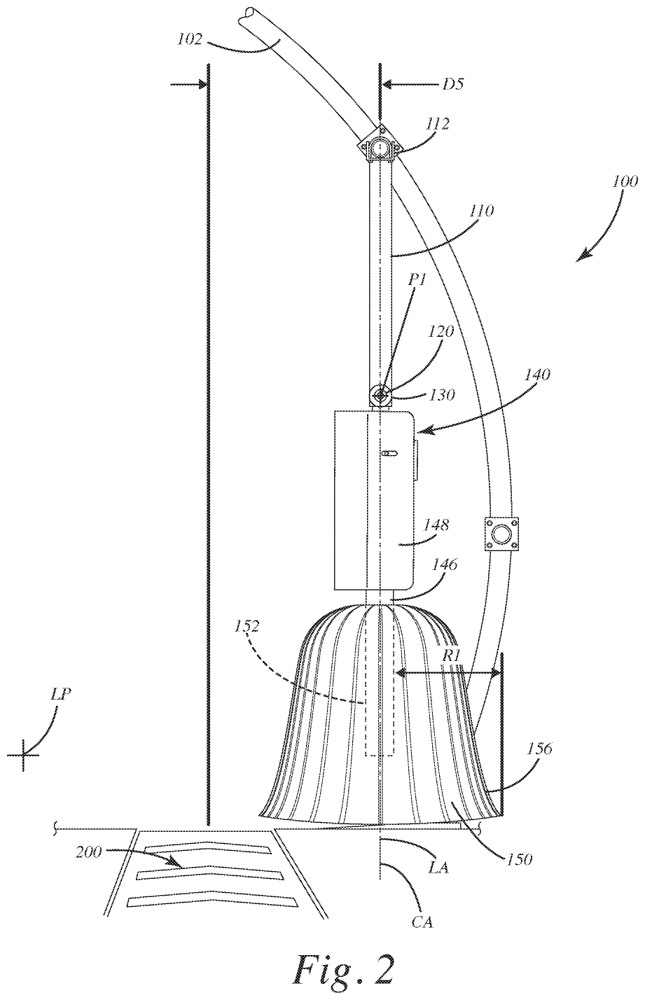

The bristles can be attached at one end to the central support member 152. Optionally, the bristles 156 can be spaced evenly across an outer surface of the central support member 152. The flexible bristles 156 each can have a first position with respect to the longitudinal axis LA and a second position with respect to the longitudinal axis LA. The first position of the bristles 156 can be substantially vertical or substantially parallel to the longitudinal axis LA and/or central axis CA of the central support as shown in FIG. 2. In this position, the bristles can be limp, and can hand downward alongside the central axis. Then the motor assembly spins the head, however, the bristles can move outward to a second position, optionally under centrifugal force so that they can be substantially horizontal or substantially perpendicular to the longitudinal axis LA or central axis CA as shown in FIGS. 1 and 6. As shown in FIG. 2, the length R1 of the bristles 156 extending away from the central axis CA can be optionally about 12 inches, about 14 inches or about 16 inches, when the rocker head is not spinning. As shown in FIG. 6, when the rocker head spins, the length R2 of the bristles 156 extending away from the central axis CA can increase, and can become greater, optionally about 20 inches, about 24 inches, about 26 inches, or about 28 inches. The bristles 156 can have lengths R1 and R2, which can vary depending on the spinning, washing, cleaning or treatment function of the rocker brush on a vehicle surface.

The rocker brush head 150 and the motor assembly 140 can have a combined second length L2. This second length L2 can be a length between the rotatable coupler 130 and a distal or lowermost end 155 of the central support member 152. The second length L2 optionally can be between 40 and 60 inches, inclusive, between 45 and 55 inches, inclusive, between 50 and 55 inches, inclusive, or about 52 inches. The overall length of the assembly 100 from the bottom of the first coupler 112 to the bottom of the rocker brush head 150 at the distal end 155 can be optionally between 75 inches and 95 inches, inclusive, between 80 inches and 90 inches, inclusive, or between 84 inches and 88 inches, inclusive, or other lengths depending on the application.

Further optionally, the first length L1 and the second length L2 can be established in a ratio of one to the other to allow the rocker head to be positioned adjacent a vehicle on the pathway LP to swing adequately, but not too rapidly, away from the vehicle surface to avoid damaging the surface, and/or to satisfactorily follow the contours of most conventional vehicles. For example, the ratio of the first length to the second length can be optionally greater than 1:1.2, greater than 1:1.4, greater than 1:1.5, between 1:1 and 1:2, or other ratios.

As mentioned above, when the motor 142 is powered, optionally by an electrical power source, the motor shaft 146 can spin and rotatably actuate the rocker brush head 150. As the rocker brush head 150 spins, the flexible bristles 156 can move from the first position to the second position. The speed at which the rocker brush head 150 spins can be configured to sufficiently clean the rocker panels of the vehicle without causing damage to the vehicle. Optionally, the speed of the rocker head can be optionally between 50 and 100 rotations per minute (“RPM”), inclusive, between 70 and 90 RPM, inclusive, between 80 and 90 RPM, inclusive, or at least 83 RPM.

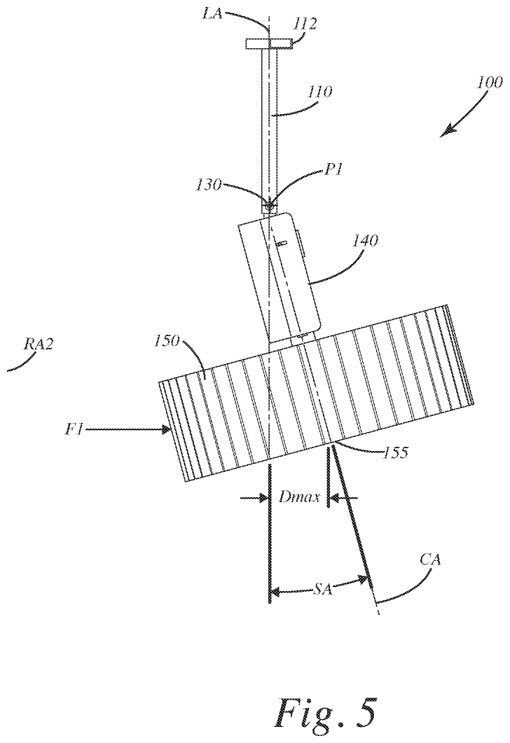

The rocker brush head 150 and the motor assembly 140 can be configured to pivot about the rotatable coupler 130 as one unit. As shown in FIG. 5, the rocker brush head 150, the motor assembly 140 and the central support 152 can pivot about the rotatable coupler 130, and in particular the pivot axis P1, when the rocker brush head 150 encounters an opposing force above a movement threshold. The amount of pivoting can be referred to as the swing of the rocker brush, and can result in the central axis CA of the central support 152 swinging through a swing angle SA relative to the longitudinal axis LA, which can be vertical.

Optionally, a movement threshold can be set to allow the rocker brush head 150 and the motor assembly 140 to swing outward to match the profile and/or contours of the vehicle. Optionally, the movement threshold can be set to the amount of force the rocker brush head 150 would encounter if a vehicle was closer to the rocker brush head 150 than the car wash was designed for and therefore the vehicle was at an increased risk of being damaged by the rocker brush head. Further optionally, the movement threshold can be a force F1 exerted by and against the vehicle, which can be optionally at least 0.5 pounds, at least 1 pound, at least 2.5 pounds, at least 5 pounds, at least 10 pounds, at least 20 pounds or at least 25 pounds.

As mentioned above, the rocker brush head 150 and the motor assembly 140 can pivot about the rotatable coupler 130 to a maximum angle or swing angle SA and a maximum distance D1 with respect to the longitudinal axis LA. The swing angle can be optionally at least 5 degrees, at least 10 degrees, at least 15 degrees, between 10 and 45 degrees, inclusive, between 10 and 20 degrees, inclusive, between 10 and 15 degrees, inclusive, between 10 and 20 degrees inclusive, or about 15 degrees, depending on the application. The maximum distance Dmax from the longitudinal axis LA to the distal end 155 of the rocker brush head 150 can be optionally at least 10 inches, at least 20 inches, at least 30 inches, between 10 and 20 inches, inclusive or about 12.5 inches. The center of mass Cm can move a distance D1 from the longitudinal axis LA when the rocker brush head 150 and the motor assembly 140 swing outward. Optionally, the maximum distance the center of mass Cm can move from the longitudinal axis LA is optionally at least 4 inches, at least 6 inches, at least 8 inches, between 4 and 8 inches, inclusive, between 6 and 7 inches, inclusive, or about 6.5 inches. This distance can be selected so that the rocker head and motor assembly do not sway excessively after a vehicle passes the assembly.

The pivoting motion of the pendulum rocker brush assembly 100 can allow for reduced maintenance of the assembly 100 because there can be optionally no bearings to grease and no shocks, springs or rubber bumpers to replace. The entire assembly can be void of bearings, springs shocks and bumpers to control, modulate or move the rocker head 150 and motor assembly 140 relative to the rocker arm 110, or to otherwise return the central axis CA of the support 152 to a vertical orientation, or parallel to the longitudinal axis LA. The angle of the pendulum rocker brush assembly 100 can be the same for all types of vehicles because the assembly 100 can pivot to match the profile of the vehicle. Once the position of the pendulum rocker brush assembly 100 is set, the assembly 100, and in particular, the rotatable coupler, needs no maintenance.

In FIG. 4, a plan view of two pendulum rocker brush assemblies 100 installed in a car wash is shown. The pendulum rocker brush assemblies 100 are shown in their resting position and at their maximum distance when pivoted about rotatable coupler 130. The rocker brush head 150 and the motor assembly 140 can pivot about the rotatable coupler 130 when the rocker brush head 150 encounters an opposing force F1 above a movement threshold. The car wash can include two conveyor belts 200. The conveyor belts 200 can move a vehicle through the car wash. In the case of the pendulum rocker brush assemblies 100, the conveyor belts 200 can move the vehicle alongside the pendulum rocker brush assemblies 100 to clean the rocker panels of the vehicle. D2 can be the distance from the longitudinal axis LA to the edge of the conveyor belt 200. D2 can be optionally between 10 and 30 inches, inclusive, between 10 and 20 inches, inclusive, or about 17 inches. D3 can be the distance between the longitudinal axis LA of the two pendulum rocker brush assemblies 100 when the assemblies are in their resting position. Put another way, D3 can be the minimum distance between the longitudinal axis LA of the two pendulum rocker brush assemblies 100. D3 can be optionally between 100 and 150 inches, inclusive, between 110 and 140 inches, inclusive, or about 129 inches. D4 can be the maximum distance between the LCP of the two pendulum rocker brush assemblies 100. Put another way, D4 can be the distance between the distal ends 152 of the central supports of the two pendulum rocker brush assemblies 100 when the pendulum rocker brush assemblies 100 are moved their maximum distance Dmax. D4 can be optionally between 125 and 200 inches, inclusive, between 140 and 160 inches, inclusive, or about 154 inches. Optionally, the ratio between D3 and D4 can be about 1:1.2. The car wash can have a center CP of the pathway LP. D5 can be the distance between the longitudinal axis LA and the center of the pathway LP. D5 can be optionally between 30 and 50 inches, inclusive, between 30 and 40 inches, inclusive, or about 32 inches. Dmax can be the maximum distance of the distal ends 152 from the longitudinal axis LA when the pendulum rocker brush assembly 100 swings outward as noted above.

As shown in FIG. 4, the vertical longitudinal axes of the rocker assemblies on opposite sides of the vehicle path LP can be disposed on a rocker axis RA1 that is perpendicular to the center CP of the pathway LP. The rocker arms can remain on this rocker axis RA1 even as the central supports 152 and rocker heads 150 of the rocker assemblies on opposite sides swing outward from the conveyor belts on opposite sides of the pathway LP. The lower distal ends 152 can be moved out and lay along a second rocker axis RA2 after the rocker heads swing their respective swing angles SA, which may or may not be equal, depending on the contact with the vehicle on opposite sides. The second rocker axis can be forward F of the first rocker axis upon such swinging. The rocker assemblies 100 also optionally can be disposed at least partially outward from the respective conveyors or paths on opposite sides of the center CP, and can remain in this lateral position relative to the pathway throughout their operation.

In one aspect, a pendulum rocker brush assembly can have a rocker arm attached to a car wash structure at one end. The rocker arm can have a first length. A coupling projection can extend perpendicularly from the rocker arm adjacent a second end of the rocker arm. A rotatable coupler can define an aperture and a coupling surface. The coupling projection can be movably joined with the aperture of the rotatable coupler. A motor assembly can include a motor and a motor shroud. The coupling surface of the rotatable coupler can be joined with a top surface of the motor shroud. The motor can include a motor body and a motor shaft. The motor shroud can surround the motor body with the motor shaft extending outside of the motor shroud. A rocker brush head can be joined with the motor shaft. The motor can actuate the rocker brush head when the motor is turned on. The rocker brush head and the motor can pivot as one unit about the rotatable coupler when the rocker brush head encounters an opposing force above a movement threshold.

In one aspect, a pendulum rocker brush assembly can include a rocker arm, a motor assembly, and a rocker brush head. The rocker arm can be fixedly attached to a car wash structure at a first end. The motor assembly can include a motor and a motor shroud. The motor can include a motor body and a motor shaft. The motor shroud can be rotatably joined with the rocker arm adjacent a second end of the rocker arm. The motor shroud can surround the motor body with the motor shaft extending outside of the motor shroud. The rocker brush head can be joined with the motor shaft. The rocker brush head can be actuated when the motor is turned on. The motor assembly and the rocker brush head can pivot outward as one unit when the rocker brush head encounters an opposing force above a movement threshold.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “joined with” another component, part or layer, it may be directly joined with, on, engaged with, adhered to, secured to, or joined with the other component, part or layer, or any number of intervening components, parts or layers may be present. In contrast, when an element is referred to as being “directly joined with,” “directly on,” “directly engaged with,” “directly adhered to,” “directly secured to,” or “directly joined with” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

What is claimed is:

1. A pendulum rocker brush assembly for use in a vehicle wash, including a vehicle pathway along which a vehicle being washed moves and a support structure extending above the vehicle pathway, the pendulum rocker brush assembly comprising:
a first coupler fixedly joined with the support structure in an immovable manner;
a rocker arm having a first length extending between a first end and a second end, the first end fixedly joined with the first coupler so that the rocker arm projects vertically downward along a longitudinal axis, in a static vertical position that is laterally offset from a vehicle pathway along which a vehicle moves in a conveyor direction, the first length being between 5 inches and 50 inches, inclusive;
a rotatable coupler joined with the second end of the rocker arm, the rotatable coupler including a pivot bushing defining an aperture and a projection rotatably disposed in the aperture, the rotatably coupler extending perpendicular to the longitudinal axis, the rotatable coupler including a pivot axis that extends perpendicular to the longitudinal axis and at a pivoting angle of between 0 degrees and 45 degrees, inclusive, relative to the conveyor direction, the rotatable coupler including a coupling surface, the coupling surface free to rotate in an unbiased manner about the pivot axis;
a motor assembly fixedly joined with the coupling surface, the motor assembly including a motor having a motor body and a motor shaft, a motor shroud surrounding the motor body, the motor shaft extending outside the motor shroud, the motor assembly suspended by gravity below the coupling surface; and
a rocker brush head including a central support member joined with the motor shaft and extending in a vertical orientation along a central support axis that is laterally offset a distance from the longitudinal axis, and a plurality of flexible bristles joined with the central support member,
wherein the motor rotatably actuates the rocker brush head when the motor is powered so that the plurality of flexible bristles move from a first position to a second position when the rocker brush head is rotatably actuated,
wherein the rocker brush head and the motor assembly joined with the coupling surface are operable to pivot about the pivot axis from a vertical orientation, where the central support axis is substantially parallel to the longitudinal axis, to a deployed position where the central support axis is disposed at a swing angle of between 10 degrees and 45 degrees, inclusive, relative to the longitudinal axis, when the rocker brush head rotates and encounters an opposing force from a vehicle moving along the conveyor in the conveyor direction.

2. The assembly of claim 1,
wherein the first position of the flexible bristles is substantially vertical, and
wherein the second position of the flexible bristles is substantially horizontal.

3. The assembly of claim 1,
wherein the first length is between 5 and 40 inches, inclusive,
wherein the central support member includes a distal end that is disposed a second length from the rotatable coupler,
wherein the second length is between 30 and 60 inches, inclusive.

4. The assembly of claim 1,
wherein the rocker brush head and the motor assembly pivot about the pivot bushing to the swing angle and to a maximum distance with respect to the longitudinal axis of the rocker arm.

5. The assembly of claim 4,
wherein the swing angle is about 15 degrees.

6. The assembly of claim 5,
wherein the maximum distance is about 12.5 inches.

7. The assembly of claim 1,
wherein each of the flexible bristles has a length between 20 and 30 inches, inclusive.

8. The assembly of claim 1,
wherein a length from the pivot axis to a distal end of the central support member is between 45 and 55 inches.

9. The assembly of claim 1,
wherein the rocker arm remains in the static vertical position as the central support member swings out the swing angle of about 15 degrees in a forward direction about the pivot axis that is disposed at the pivoting angle of about 22.5 degrees relative to the conveyor direction so that the rocker head does not damage a surface of the vehicle.

10. The assembly of claim 1,
wherein the rocker arm remains in the static vertical position as the central support member swings out the swing angle between 10 degrees and 15 degrees, inclusive, in a forward direction about the pivot axis that is disposed at the pivoting angle between 20 degrees and 25 degrees, inclusive, relative to the conveyor direction so that the rocker head does not damage a surface of the vehicle.

11. A pendulum rocker brush assembly for use in a vehicle wash, including a vehicle pathway along which a vehicle being washed moves and a support structure extending above the vehicle pathway, the pendulum rocker brush assembly comprising:
a first coupler fixedly joined with the support structure in an immovable manner;
a rocker arm having a first length extending between a first end and a second end, the first end fixedly joined with the first coupler so that the rocker arm projects vertically downward along a longitudinal axis, in a vertical position that is laterally offset from a vehicle pathway along which a vehicle moves in a conveyor direction;
a rotatable coupler joined with the second end of the rocker arm, the rotatable coupler including a pivot bushing defining an aperture and a projection rotatably disposed in the aperture the rotatably coupler extending transverse to the longitudinal axis, the rotatable coupler including a pivot axis that extends transverse to the longitudinal axis, the rotatable coupler including a coupling surface, the coupling surface free to rotate in an unbiased manner about the pivot axis;
a motor assembly fixedly joined with the coupling surface, the motor assembly including a motor having a motor body and a motor shaft, a motor shroud surrounding the motor body, the motor shaft extending outside the motor shroud, the motor assembly suspended by gravity below the coupling surface; and
a rocker brush head including a central support member joined with the motor shaft and extending in a vertical orientation along a central support axis that is laterally offset a distance from the longitudinal axis, and a plurality of flexible bristles joined with the central support member,
wherein the motor rotatably actuates the rocker brush head when the motor is powered so that the plurality of flexible bristles move from a first position to a second position when the rocker brush head is rotatably actuated,
wherein the rocker brush head and the motor assembly joined with the coupling surface are operable to pivot about the pivot axis from a vertical orientation, where the central support axis is substantially parallel to the longitudinal axis, to a deployed position where the central support axis is disposed at a swing angle of between 0 degrees and 45 degrees, inclusive, relative to the longitudinal axis, when the rocker brush head rotates and encounters an opposing force from a vehicle moving along the conveyor in the conveyor direction.

12. The assembly of claim 11,
wherein the central support member defines a support aperture,
wherein the motor shaft is joined with the rocker brush through the support aperture,
wherein the plurality of flexible bristles are each joined at a first end to the central support member,
wherein the plurality of flexible bristles are in a first position when the motor is unpowered and in a second position when the motor is powered.

13. The assembly of claim 11,
wherein the first position is substantially parallel to the rocker arm,
wherein the second position is substantially perpendicular to the rocker arm.

14. The assembly of claim 13,
wherein the rocker arm remains in the vertical position as the central support member swings out the swing angle between 10 degrees and 15 degrees, inclusive, in a forward direction about the pivot axis that is disposed at the pivoting angle between 20 degrees and 25 degrees, inclusive, relative to the conveyor direction so that the rocker head does not damage a surface of the vehicle.

15. The assembly of claim 14,
wherein the swing angle is about 15 degrees.

16. The assembly of claim 15,
wherein the rocker brush head and the motor assembly pivot about the pivot axis to a maximum distance with respect to the longitudinal axis of the rocker arm,
wherein the maximum distance is between 10 inches and 20 inches.

17. A pendulum rocker brush assembly for use in a vehicle wash, including a vehicle pathway along which a vehicle being washed moves and a support structure extending above the vehicle pathway, the pendulum rocker brush assembly comprising:
a rocker arm, the rocker arm being fixedly joined with and suspended by the support structure at a first end;
a motor assembly including a motor and a motor shaft the motor assembly being rotatably joined with the rocker arm adjacent a second end of the rocker arm in an unbiased manner; and
a rocker brush head joined with the motor shaft,
wherein the rocker brush head and the motor assembly pivot outward, when the rocker brush head encounters an opposing force above a movement threshold due to a vehicle moving along a conveyor direction, to a pivoting angle between 10 degrees and 45 degrees, inclusive, relative to the conveyor direction, and to a swing angle between 10 degrees and 45 degrees.

18. The assembly of claim 17,
wherein the rocker brush head and the motor assembly pivot about a pivot axis from a vertical orientation in which a central support axis of the rocker brush head is substantially parallel to a longitudinal axis of the rocker arm, to a deployed position where the central support axis is disposed at the swing angle between 10 degrees and 20 degrees, inclusive, relative to the longitudinal axis.

19. The assembly of claim 17, comprising:
a central support member defining a support aperture, the motor shaft joined with the rocker brush via the support aperture; and
a plurality of flexible bristles attached to the central support member at a first end of each of the plurality of flexible bristles,
wherein the plurality of flexible bristles are in a first position when the motor is unpowered, and in a second position when the motor is powered.

20. The assembly of claim 19,
wherein the first position is substantially parallel to the rocker arm,
wherein the second position is substantially perpendicular to the rocker arm.
